(19) United States
(12) Patent Application Publication
(10) Pub. No.: US 2014/0289026 A1
(43) Pub. Date: Sep. 25, 2014

(54) APPARATUS AND METHOD FOR DETERMINING TRIP INFORMATION

(71) Applicant: SIEMENS AKTIENGESELLSCHAFT, MUENCHEN (DE)

(72) Inventor: Peter Neumann, Muenchen (DE)

(21) Appl. No.: 14/356,951

(22) PCT Filed: Oct. 29, 2012
(86) PCT No.: PCT/EP2012/071327

§ 371 Date: May 8, 2014

(30) Foreign Application Priority Data
Nov. 11, 2011 (DE) 102011086192.0

(51) Int. Cl. G06Q 30/04; G07B 15/02; G01S 5/02

(52) U.S. Cl. CPC G06Q 30/04; G01S 5/02; G07B 15/02
USPC 705/13; 342/450

(57) ABSTRACT

A device determines trip information related to a route travelled by a passenger. In order to provide a solution for automatically verifying trip information and for enhancing passenger comfort when using public transportation, the device includes a receiver that can be carried by the passenger and receives a signal generated by a ground-based local transmitter, and a processor for determining at least one bit of trip information by signal evaluation in which at least one signal characteristic of a received signal is evaluated.

The invention relates to an apparatus for determining trip information based on a route traveled by a passenger, having a receiving unit, which can be carried by the passenger and is intended to receive a signal generated by a ground-based, location-based transmitting unit, and a computing unit for determining at least one item of trip information using signal evaluation during which at least one signal property of a received signal is evaluated.

The use of electronic means, in particular mobile telephones, in connection with the purchase, production and validation of travel tickets in public transport is nowadays widespread. Despite the simplification achieved in comparison with the purchase of conventional tickets in paper form, said operations still presuppose actions or measures by the passenger before starting a journey. For example, travel tickets purchased and present in paper or electronic form must be validated at a ground-based validation station before commencing a journey and/or by vehicle staff during the trip.

US 2008/0215380 A1 describes a system for automatically calculating a fare. Train stations and vehicles are equipped with fixed devices which are specifically intended to output information to a reader belonging to the passenger, which information is used as a basis for calculating the fare. Although the purchase and validation of a ticket can be dispensed with, actions by the passenger, in particular actively attaching the reader to the fixed devices, are required.

EP 1 777 659 A1 discloses another system for invoicing a used service on the basis of communication between a transmitter, which is arranged in a public transport vehicle, and a terminal belonging to the passenger. It is assumed that the transmission range of the transmitters is restricted to the interior of the vehicle.

The invention is based on the object of providing a solution which can be used to automatically verify trip information and can be used to increase the comfort of the passenger when using public means of transport.

In this respect, it is proposed that a first signal property is an item of network identification information relating to a ground-based local area network, and, if a plurality of networks are detected at the same time, the computing unit is intended to evaluate a temporal sequence of the signal amplitude as a further signal property in order to determine the trip information.

It is possible to determine an item of trip information using a received signal in a particularly simple manner by virtue of a first signal property being in the form of coded information contained in the signal. The coded information is an item of network identification information relating to a ground-based local area network, as a result of which the stay of the passenger in the transmission range of a ground-based local area network can be determined in a particularly simple manner.

If the computing unit detects a plurality of networks at the same time, it is advantageous, in order to determine an unambiguous item of trip information, that a temporal sequence of the signal amplitude is evaluated by the computing unit as a further signal property in order to determine the trip information. In this case, a receiving operation is monitored, in particular, with respect to the increase in signal amplitude during signal evaluation. The approach of a location-based transmitting unit can be advantageously unambiguously assigned to the increase in a signal amplitude, as a result of which unambiguous localization can be achieved. This is advantageous, in particular, in a situation in which a signal from a first transmitting unit assigned to a first location is still received outside the provided transmission range of the first transmitting unit, for example as a result of reflection. The increase in the signal amplitude of a further signal generated by a second transmitting unit assigned to a second location can be used to determine approach to the second location and a stay at the first location can therefore be excluded.

A “location-based” transmitting unit expediently generates signals, in particular radio signals, which can preferably be assigned to a particular, locally restricted location with a defined function, in particular a device for a public means of transport such as a station, a train station or a bus stop. The transmitting unit is preferably part of a network covering a transmission range which is at most 1 km in its largest extent. In another embodiment, it is conceivable that the receiving unit is intended to receive a signal from a transmitting unit which is in the form of an RFID unit.

The use of signals from location-based transmitting units has the advantage that it is possible to quickly and easily assign the signals to a particular device since the transmission range per se is restricted to a spatially limited device. Such local area networks are already known and in operation, the use of the apparatus according to the invention not requiring any considerable adaptation of existing local area networks.

A “ground-based” transmitting unit is intended to be understood as meaning, in particular, a transmitting unit which, in contrast to signal generation from a satellite, is intended to transmit from the ground area. The use of signals from ground-based transmitting units makes it possible to determine trip information along a route which is at least partially underground, the transmitting unit being able to be assigned to a station arranged underground.

A ground-based transmitting unit may be fixed relative to the ground or may be arranged in a vehicle moving on the ground.

One preferred embodiment of the invention proposes that the apparatus comprises a unit which can be carried by the passenger and comprises at least the receiving unit and the computing unit, thus making it possible to achieve a construction ally simple configuration with short transmission paths between the receiving unit and the computing unit. A unit which “can be carried” is intended to be understood as meaning, in particular, a unit which is specifically designed, in particular dimensioned, for mobile operation by the passenger. In particular, the unit is dimensioned in such a manner that it can be stowed in a carrying means belonging to the passenger, for example a pocket or an item of clothing. The unit which can be carried may be in the form of a mobile telephone, in particular. The technologies available nowadays and the increasing user friendliness can be used in a particularly advantageous manner to easily retrofit an existing mobile telephone with software or an application which is intended at least to determine the trip information using the receiving unit and the computing unit. This software or application may be provided for downloading, for example, by an operator of the route traveled. In another embodiment, the unit which can be carried can be directly carried on the passenger's body by virtue of it being in the form of an item of jewelry, a necklace, a bangle or a watch, for example.

An item of “trip information” is expediently used to determine the route traveled by the passenger. In this context, it is proposed that, if the transmitting unit is assigned to a station, the computing unit is intended to use the signal evaluation to determine an item of trip information with respect to a stay of the passenger in the station. This makes it possible to verify the stay of the passenger in a station as trip information, which can be used to determine the start and end of the route, in a particularly simple manner using signal evaluation.

It is also proposed that, if the transmitting unit is arranged in a vehicle, the computing unit is intended to use signal evaluation to determine an item of trip information with respect to a stay of the passenger in the vehicle, thus making it possible to verify a stay of the passenger in the vehicle as trip information in a particularly simple manner using signal evaluation.

An item of time information can also be assigned to an item of trip information, which time information is used, in particular, to determine at least one period in which the vehicle is used.

A billing operation in connection with the route traveled can also be handled in a particularly efficient manner if the apparatus has an evaluation unit which is intended to use the trip information relating to the route traveled to determine trip costs. This makes it possible to advantageously automate the billing operation by virtue of the latter being handled after the end of the journey using the trip information. This dispenses with the need to purchase a ticket before starting a journey and with further measures by the passenger for verifying the route traveled. In this case, the billing operation can take into account, in a particularly advantageous manner, any desired number of trip interruptions and/or vehicle changes during changing by the passenger which are effected along the route.

The evaluation unit may be part of a unit which can be carried and, as described above, comprises the receiving unit and the computing unit. In this case, the unit which can be carried is preferably provided with a storage unit which stores a database which contains tariff information for the basis of cost determination and is regularly updated.

However, in order to make it possible to centrally determine journey costs, which determination is carried out in particular using tariff information which is always up-to-date, it is proposed that the unit which can be carried is intended to transmit the trip information to the evaluation unit by establishing a wireless data connection to the latter. The trip information can be transmitted after conclusion of the journey by the passenger, in which case the unit which can be carried expediently has at least one storage unit which is intended to store the trip information and is operatively connected to the computing unit and a permanent connection to a public data network is not required, or in real time immediately after the computing unit has determined an item of trip information.

In another refinement of the invention, it is proposed that the apparatus has an evaluation unit which is intended to determine trip costs using the trip information relating to the route traveled and to take into account time information associated with the trip information. The practice of taking into account time information, for example a time at which a journey starts, a time at which a journey ends, a journey duration, a journey frequency etc., makes it possible to automatically choose between different tariffs which apply to the route traveled for different journey times or are dependent on a journey frequency. In particular, the most favorable tariff for this route can be selected. When taking into account a journey frequency, a tariff level which is more favorable, in terms of price, for multiple use of the route traveled than for individual trips is taken into account in a particularly advantageous manner.

The invention also relates to a method for determining trip information based on a route traveled by a passenger, in which a signal which is generated by a ground-based, location-based transmitting unit is received by a receiving unit which can be carried by the passenger, and at least one signal property of the signal is evaluated during signal evaluation, at least one item of trip information being determined using the signal evaluation.

It is proposed that a first signal property is an item of network identification information relating to a ground-based local area network, and that, if a plurality of networks are detected at the same time, a temporal sequence of the signal amplitude is evaluated as a further signal property in order to determine the trip information. With respect to the advantageous effects of the proposed method, reference is made to the above statements with respect to the apparatus.

It is also proposed that trip costs are determined using the trip information relating to the route traveled, thus making it possible to advantageously automate the billing operation by virtue of the latter being handled after the end of the journey using the trip information. This dispenses with the need to purchase a ticket before starting a journey and with further measures by the passenger in order to verify the route traveled.

One exemplary embodiment of the invention is explained using the figures, in which:

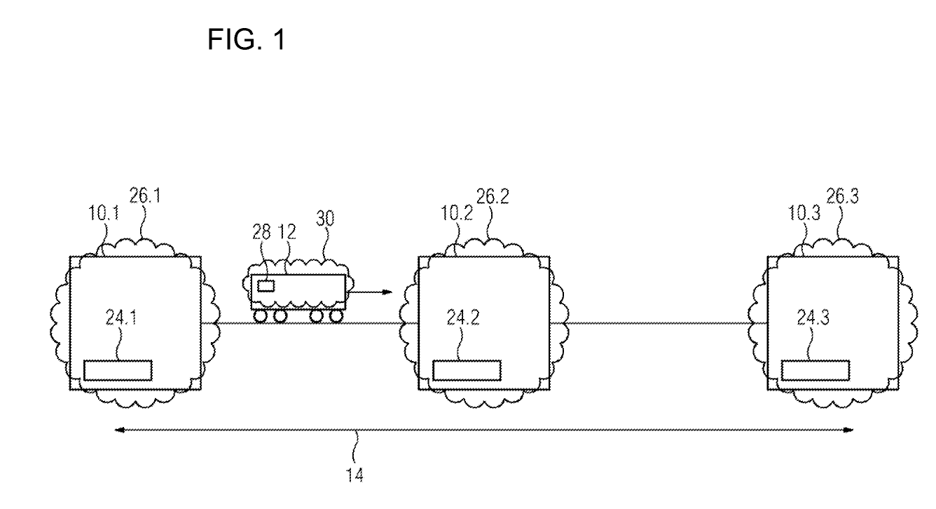

FIG. 1: shows a starting station, a destination station, an intermediate station, and a route traveled by a passenger between the starting station and the destination station in a vehicle, the stations and the vehicle each being provided with a transmitting unit,

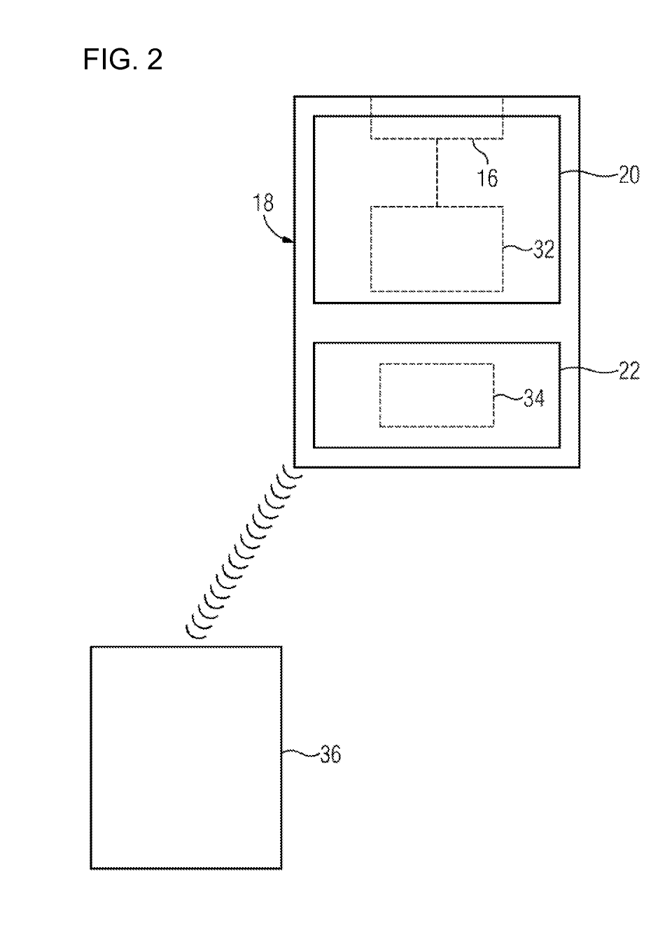

FIG. 2: shows a unit which is carried by the passenger and is intended to communicate with the transmitting units, and

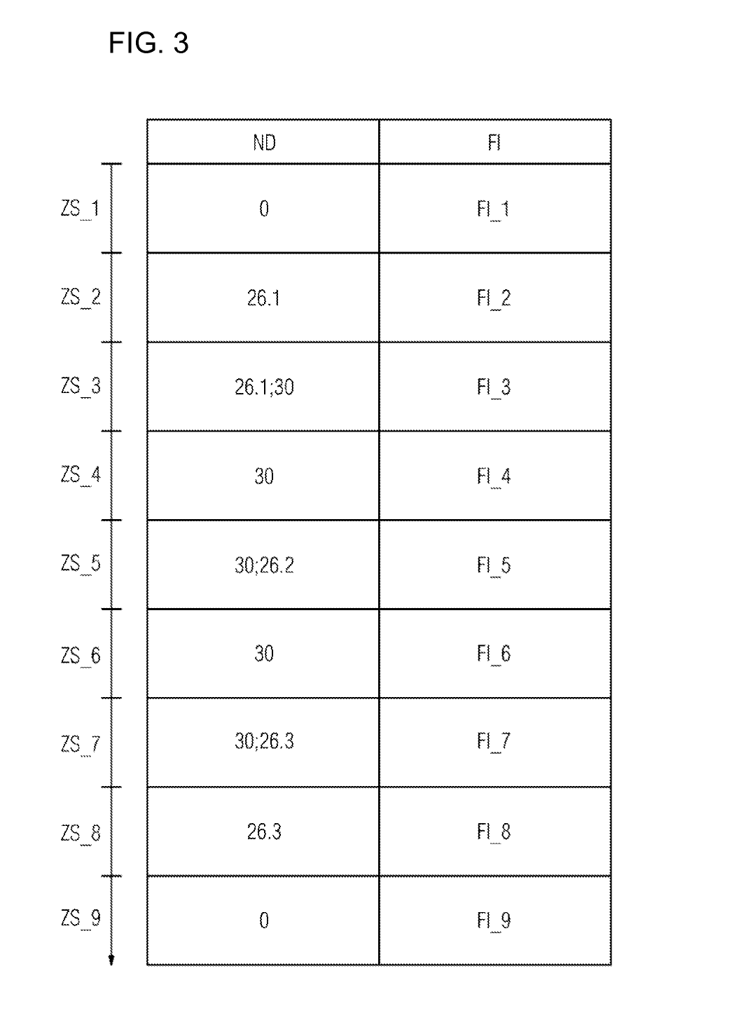

FIG. 3: shows a method for determining the route traveled using the unit.

FIG. 1 shows a highly schematic view of three stations 10.1, 10.2, 10.3 for a vehicle 12, in particular a public means of transport, for example a rail vehicle, an omnibus etc. If the vehicle 12 is in the form of a rail vehicle, the stations 10 each correspond to a train station or a stop. In particular, at least one station 10 can be an underground station.

It is assumed, by way of example, that the station 10.1 corresponds to the starting station and the station 10.3 corresponds to the destination station of a passenger. The route between the starting station 10.1 and the destination station 10.3 is therefore a route 14 traveled by the passenger. A further station is likewise approached along the route 14 and is considered to be an intermediate station 10.2 in this exemplary embodiment.

Before commencing his or her journey, during his or her journey and preferably also after the end of the journey, the passenger carries a receiving unit 16 which is illustrated in more detail in FIG. 2. The receiving unit 16 is part of a unit 18 which can be carried and is dimensioned in such a manner that it can be stowed, in particular, in an item of clothing belonging to the passenger, for example in a pocket. In the exemplary embodiment under consideration, the unit 18 is also provided with an output unit 20 for outputting an item of information to the passenger and with an input unit 22 for the input of an item of information by the passenger. In particular, the unit 18 which can be carried is in the form of a mobile telephone which is provided with software for carrying out the method described below. Alternatively, the unit 18 which can be carried may be in the form of a portable computer, for example in the form of a laptop or a tablet PC.

The stations 10 on the route 14 are each provided with a ground-based transmitting unit 24 which is assigned to the corresponding station 10 (FIG. 1). The assignment is effected, in particular, by virtue of the transmitting unit 24 generating signals, in particular radio signals, which can be used to establish an assignment to the respective station 10. In this case, the transmitting unit 24 can be part of a local area network 26 which, in the exemplary embodiment under consideration—based on transport using rail vehicles, is in the form of a “train station network”, signals generated by the transmitting unit 24 containing an item of coded network identification information. The transmitting unit 24 is also preferably designed to emit signals into the station area or at least into part of the station area, emission beyond the limits of the station area not being provided and not being preferred. The local area networks 26 may be in the form of WLAN (“Wireless LAN”) and/or in the form of other radio networks which appear to be useful to a person skilled in the art, for example in the form of a DECT (Digital Enhanced Cordless Telecommunications) network, in particular in the form of mobile radio networks, for example GSM, UMTS, LTE and/or CDMA, CDMA 2000 and IMT 2000 networks. If at least one local area network 26 is in the form of a WLAN, the above-mentioned network identification information may correspond to an SSID (“Service Set Identifier”) identification or a network identification of the generic type.

The vehicle 12 which is used to travel the route 14 is provided with a transmitting unit 28 which is, in particular, part of a local area network 30 of the vehicle 12. This local area network 30 may be in the form of a WLAN and signals generated by the transmitting unit 28 can be assigned to the vehicle 12 using an item of coded network identification information contained in the signals.

The receiving unit 16 (FIG. 2) is intended to receive signals generated by the local transmitting units 26 and 28. The unit 18 has a computing unit 32 which is connected downstream of the receiving unit 16 and is used to evaluate at least one signal property of the signals received by the receiving unit 16. The result of the signal evaluation represents at least one item of trip information which is based on the route 14 traveled by the passenger.

The receiving unit 16 and the computing unit 32, in interaction with the transmitting units 26, 28, are used to provide an apparatus which is able to determine at least the following trip information relating to the passenger: stay of the passenger in the starting station 10.1, stay of the passenger in the vehicle 12, stay of the passenger in the destination station 10.3 and departure from the destination station 10.3. This is referred to as trip information FI and is illustrated in FIG. 3.

FIG. 3 shows a temporal sequence of the passenger's journey in tabular form. The columns of the table have the following meaning: ND corresponds to the detection of signals from one or more of the local area networks 26, 30 using the receiving unit 16 and the computing unit 32, and FI corresponds to the determination of a corresponding item of trip information.

During the period ZS_{—}1, it is not possible to receive a signal which can be used to establish an assignment to a station 10 or a vehicle. This is symbolically illustrated in the column ND using a “0”. The trip information FI_{—}1 determined by the computing unit 32 is the fact that the passenger is not in a station area.

During the period ZS_{—}2, the computing unit 32 is used to detect the network identification information relating to the local area network 26.1 assigned to the station 10.1.

The trip information FI_{—}2 that the passenger is in the area of the station 10.1 follows there from.

If the vehicle 12 approaches the station area and/or if the vehicle 12 stays in the station 10.1, the receiving unit 16 is used in the period ZS_{—}3 to receive a signal from the network 30 in addition to signals from the transmitting unit 24.1 and the computing unit 32 assigns said signal to the vehicle 12. The alternatives that the passenger is in the vicinity of the vehicle 12 or is in the vehicle 12 follow as trip information FI_{—}3 from this assignment.

The alternatives can be restricted to an unambiguous item of trip information FI_{—}4 in the subsequent period ZS_{—}4 either by virtue of signals generated by the transmitting unit 24.1 still being received with substantially the same amplitude and signals from the transmitting unit 28 being received with decreasing amplitude or the reverse configuration being detected. The first-mentioned case results in the trip information that the passenger has not entered the vehicle 12 and the latter has departed, whereas the trip information FI_{—}4 that the passenger is in the moving vehicle 12 is derived using the computing unit 32 from the reverse configuration in which the signals from the local area network 26.1 disappear and the signals from the local area network 30 are received with substantially the same amplitude.

The local area network 26.2 of the intermediate station 10.2 is identified in the period ZS_{—}5, the trip information FI_{—}5 corresponding to the alternatives that the passenger is still in the vehicle 12 or has alighted from the latter.

In the period ZS_{—}6, the trip information FI_{—}6 is restricted to the first-mentioned alternative. In the periods ZS_{—}7 and ZS_{—}8, a local area network 26 is detected again, to be precise the local area network 26.3 of the destination station 10.3, in which case further alternatives—alighting or continuation of the trip—are determined in the period ZS_{—}7 as trip information FI_{—}7 and alighting of the passenger in the destination station 10.3 is determined as trip information FI_{—}8 by the disappearance of signals from the network 30 in the period ZS_{—}8. In the period ZS_{—}9, it is not possible to establish any assignments to station-based or vehicle-based signals, in which case the trip information FI_{—}9 corresponds to the departure from the destination station.

In the method described above, an item of time information (ZS_{—}1 to ZS_{—}9) can be assigned to each of the detected situations (FI_{—}1 to FI_{—}9). The trip information FI is stored, in particular together with the corresponding time information, in a storage unit 34 of the unit 18 which can be carried (FIG. 2).

In order to determine the trip costs in connection with the route 14 traveled, provision is made of an evaluation unit 36 which is used to determine the costs using the trip information FI relating to the route 14 traveled. In the exemplary embodiment under consideration according to FIG. 2, the evaluation unit 36 corresponds to a central computing unit to which the unit 18 which can be carried establishes a wireless data connection in order to communicate the trip information FI and possibly the time information thereto.

The evaluation unit 36 can calculate the trip costs using the pure route 14 or can take into account the time information in order to choose between different tariffs available for this route 14, in particular.

Instead of transmitting the trip and possibly time information once to the evaluation unit 36 after the end of the journey, an item of trip information FI determined by the computing unit 32 can be directly transmitted to the evaluation unit 36 in real time after it has been determined, the evaluation unit possibly itself assigning an item of time information to this trip information.

Further operations in connection with the determination of the trip information and with the determination of the journey costs can be carried out using the output unit 20 and the input unit 22 of the unit 18 which can be carried. For example, the payment of the calculated costs can be controlled. Furthermore, the passenger can be informed of the route 14 traveled using the output unit 20. The determined trip information FI can be output, for example in the form of text and/or using a color code. The entering and use of the selected vehicle 12 can also be acknowledged by the passenger.

In the exemplary embodiment under consideration, it was assumed that the station 10.3 corresponds to the passenger's destination station. If the passenger changes in the station 10.3, trip information relating to the continuation of the trip with a further vehicle can also be collected.

1-9. (canceled)

10. An apparatus for determining trip information based on a route traveled by a passenger, the apparatus comprising:
a receiving unit carried by the passenger and for receiving a signal generated by a ground-based, location-based transmitting unit; and
a computing unit for determining at least one item of trip information using signal evaluation during which at least one signal property of a received signal is evaluated, the at least one signal property being an item of network identification information relating to a ground-based local area network, and, if a plurality of ground-based local area networks are detected at a same time, said computing unit evaluating a temporal sequence of a signal amplitude as a further signal property in order to determine the trip information.

11. The apparatus according to claim 10, further comprising a unit carried by the passenger and containing said at least the receiving unit and said computing unit.

12. The apparatus according to claim 10, wherein if the ground-based, location-based transmitting unit is assigned to a station, said computing unit uses the signal evaluation to determine the item of trip information with respect to a stay of the passenger in the station.

13. The apparatus according to claim 10, wherein if the ground-based, location-based transmitting unit is arranged in a vehicle, said computing unit uses the signal evaluation to determine the item of trip information with respect to a stay of the passenger in the vehicle.

14. The apparatus according to claim 11, further comprising an evaluation unit which uses the trip information relating to the route traveled to determine trip costs.

15. The apparatus according to claim 14, wherein said unit transmits the trip information to said evaluation unit by establishing a wireless data connection to said evaluation unit.

16. The apparatus according to claim 14, wherein said evaluation unit is intended to take into account time information associated with the trip information.

17. A method for determining trip information based on a route traveled by a passenger, which comprises the steps of:
receiving a signal generated by a ground-based, location-based transmitting unit via a receiving unit being carried by the passenger;
evaluating at least one signal property of the signal during signal evaluation; and
determining at least one item of trip information using the signal evaluation, the at least signal property is an item of network identification information relating to a ground-based local area network, and in that, if a plurality of networks are detected at a same time, evaluating a temporal sequence of a signal amplitude as a further signal property in order to determine the trip information.

18. The method according to claim 17, which further comprises determining trip costs using the trip information relating to the route traveled.
